(19) United States
(12) Patent Application Publication
(10) Pub. No.: US 2019/0352544 A1
(43) Pub. Date: Nov. 21, 2019

(54) PHASE SEPARATED PRESSURE-SENSITIVE ADHESIVE COMPOSITIONS

(71) Applicant: 3M INNOVATIVE PROPERTIES COMPANY, St. Paul, MN (US)

(72) Inventors: Ying Lin, Woodbury, MN (US); Dong-Wei Zhu, North Oaks, MN (US); Thomas Q. Chastek, St. Paul, MN (US); Nicole Morozowich Beveridge, Stillwater, MN (US); Matthew J. Younker, St. Paul, MN (US); Caleb W. Brian, North St. Paul, MN (US); Emilie L. Rexeisen, Mendota Heights, MN (US)

(21) Appl. No.: 16/469,702

(22) PCT Filed: Dec. 19, 2017
(86) PCT No.: PCT/US2017/067280

§ 371 Date: Jun. 14, 2019

Related U.S. Application Data
(60) Provisional application No. 62/437,976, filed on Dec. 22, 2016.

(51) Int. Cl. C09J 11/06; C09J 7/38

(52) U.S. Cl. CPC C09J 11/06; C08K 5/20; C09J 7/385

(57) ABSTRACT

Adhesive articles are provided that can be repositioned (moved) prior to final adherence to a substrate. More specifically, the adhesive articles include a pressure-sensitive adhesive layer that contains an elastomeric (meth)acrylic-based polymeric material plus crystalline material that includes a fatty amide compound on the outer surface. The presence of the crystalline material does not adversely affect the final peel adhesion of the pressure-sensitive adhesive but allows the adhesive article to be moved or repositioned, if necessary, by lowering the tackiness of the surface.

### CROSS REFERENCE TO RELATED APPLICATION

This application claims the benefit of U.S. Provisional Patent Application No. 62/437976, filed Dec. 22, 2016, the disclosure of which is incorporated by reference herein in its entirety.

### BACKGROUND

It can be challenging to attach adhesive articles to large areas of a substrate with creating wrinkles or defects in the attached article. In some instances, it may be necessary to move or reposition the adhesive article before it is firmly attached to the substrates. In many known adhesive articles, the ability to move or reposition the adhesive article can have a deleterious effect on the final peel strength of the adhesive article.

### SUMMARY

Adhesive articles are provided that can be repositioned (moved) prior to final adherence to a substrate. More specifically, the adhesive articles include a pressure-sensitive adhesive layer that contains an elastomeric (meth)acrylic-based polymeric material plus crystalline material that includes a fatty amide compound on the outer surface. The presence of the crystalline material does not adversely affect the final peel adhesion of the pressure-sensitive adhesive but allows the adhesive article to be moved or repositioned, if necessary, by lowering the tackiness of the surface.

In a first aspect, an adhesive article is provided that includes a first substrate and a pressure-sensitive adhesive layer positioned adjacent to the first substrate. The pressure-sensitive adhesive contains a (meth)acrylic-based polymeric material and crystalline material on a surface of the pressure-sensitive adhesive layer opposite the first substrate. The crystalline material includes an amide compound of formula R¹—(CO)NH—R²that has a melting point in a range of 80° C. to 140° C. The group R¹ is an alkyl or alkenyl groups having at least 11 carbon atoms and the group R² is hydrogen or an alkyl.

In a second aspect, a method of making an adhesive article is provided. The method includes forming a mixture containing a solution that includes 1) a (meth)acrylic-based polymeric material and 2) an amide compound of formula R¹—(CO)NH—R² having a melting point in a range of 80° C. to 140° C. The group R¹ is an alkyl or alkenyl groups having at least 11 carbon atoms thereof and the group R² is hydrogen or alkyl. The method further includes positioning a layer of the mixture adjacent to a first substrate. The method still further includes drying the mixture to form a pressure-sensitive adhesive layer adjacent to the first substrate, wherein a surface of the pressure-sensitive adhesive layer opposite the first substrate contains crystalline material that includes the amide compound.

### BRIEF DESCRIPTION OF THE DRAWINGS

FIG. 1 is an atomic force micrograph of Example 3, which describes a pressure-sensitive adhesive containing 0.75 parts stearamide per 100 parts (meth)acrylic-based polymeric material.

FIG. 2 is an atomic force micrograph of Example 4, which describes a pressure-sensitive adhesive containing 1.0 parts stearamide per 100 parts (meth)acrylic-based polymeric material.

FIG. 3 is an atomic force micrograph of Example 5, which describes a pressure-sensitive adhesive containing 2.0 parts stearamide per 100 parts (meth)acrylic-based polymeric material.

FIG. 4 is an atomic force micrograph of Example 7, which describes a pressure-sensitive adhesive containing 2.0 parts lauramide per 100 parts (meth)acrylic-based polymeric material. FIG. 5 is an atomic force micrograph of Example 8, which describes a pressure-sensitive adhesive containing 2.0 parts erucylamide per 100 parts (meth)acrylic-based polymeric material.

### DETAILED DESCRIPTION

Adhesive articles are provided that can be repositioned (moved) prior to final adherence to a substrate. More specifically, the adhesive articles include a pressure-sensitive adhesive (PSA) layer that contains an elastomeric (meth)acrylic-based polymeric material plus a crystalline material on an outer surface. The crystalline material typically reduces the surface tack without adversely affecting the final peel adhesion to the substrate.

As used herein, the term “a” or “an” is equivalent to the expression “at least one”.

As used herein, the term “and/or” with reference to two versions A and B means only A, only B, or both A and B.

As used herein, the term “polymer” or similar words such as “polymeric” refers to a polymeric material formed from one or more monomers. The polymer can be homopolymer, copolymer, terpolymer, and the like. The term “copolymer” means that there are at least two monomers used to form the polymer.

As used herein, the term “alkyl” refers to a monovalent radical of an alkane, which is a saturated hydrocarbon. The alkyl group can have up to 30 carbon atoms, up to 26 carbon atoms, up to 24 carbon atoms, up to 20 carbon atoms, up to 18 carbon atoms, up to 16 carbon atoms, up to 12 carbon atoms, up to 10 carbon atoms, up to 6 carbon atoms, or up to 4 carbon atoms and has at least 1 carbon atom, at least 2 carbon atoms, or at least 3 carbon atoms.

As used herein, the term “alkenyl” refers to monovalent radical of an alkene, which is a hydrocarbon having at least one carbon-carbon double bond. The alkenyl group can have up to 30 carbon atoms, up to 26 carbon atoms, up to 20 carbon atoms, up to 18 carbon atoms, up to 16 carbon atoms, up to 12 carbon atoms, up to 10 carbon atoms, up to 8 carbon atoms, or up to 6 carbon atoms and has at least 2 carbon atoms, at least 3 carbon atoms, at least 4 carbon atoms, or at least 5 carbon atoms.

More particularly, an adhesive article is provided that includes a first substrate and a pressure-sensitive adhesive layer positioned adjacent to the first substrate. The pressure-sensitive adhesive contains a (meth)acrylic-based polymeric material and a crystalline material on a surface of the pressure-sensitive adhesive layer opposite the first substrate. The crystalline material contains an amide compound of formula R¹—(CO)NH—R²that has a melting point in a range of 80° C. to 140° C. The group R¹ is an alkyl or alkenyl groups having at least 11 carbon atoms and the group R² is hydrogen or an alkyl.

(Meth)acrylic-based polymeric material

The (meth)acrylic-based polymeric material is formed primarily from one or more monomers that have a (meth)acryloyl group, which is a group of formula CH₂═CHR—(CO)— where R is hydrogen or methyl. In some embodiments, at least 60 weight percent, at least 70 weight percent, at least 80 weight percent, at least 85 weight percent, at least 90 weight percent, at least 95 weight percent, at least 98 weight percent, at least 99 weight percent, or 100 weight percent of the monomers used to form the (meth)acrylic-based polymeric material have a (meth)acryloyl group.

The (meth)acrylic-based polymeric material is an elastomeric material and typically has a glass transition temperature that is no greater than 20° C., no greater than 10° C., no greater than 0° C., no greater than −10° C., or no greater than −20° C. The glass transition temperature can be determined using methods such as Differential Scanning calorimetry or Dynamic Mechanical Analysis. Alternatively, the glass transition temperature can be estimated using the Fox equation. Lists of glass transition temperatures for homopolymers are available from multiple monomer suppliers such as from BASF Corporation (Houston, Tex., USA), Polysciences, Inc. (Warrington, Pa., USA), and Aldrich (Saint Louis, Mo., USA) as well as in various publications such as, for example, Mattioni et al., J. Chem. Inf. Comput. Sci., 2002, 42, 232-240.

The (meth)acrylic-based polymeric material is formed from a monomer composition that includes a low Tg monomer based on a total weight of monomers in the monomer composition. The term “low Tg monomer” refers to a monomer that has a glass transition temperature no greater than 20° C. when polymerized as a homopolymer. That is, a homopolymer formed from the low Tg monomer has a glass transition temperature no greater than 20° C. The glass transition temperature of the homopolymer is often no greater than 10° C., no greater than 0° C., no greater than −10° C., or no greater than -20° C. Suitable low Tg monomers are often selected from an alkyl (meth)acrylate, a heteroalkyl (meth)acrylate, an aryl substituted alkyl acrylate, or an aryloxy substituted alkyl acrylate.

Example low Tg alkyl (meth)acrylate monomers often are non-tertiary alkyl acrylates but can be an alkyl methacrylates having a linear alkyl group with at least 4 carbon atoms. Specific examples of alkyl (meth)acrylates include, but are not limited to, methyl acrylate, ethyl acrylate, n-propyl acrylate, n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, and n-dodecyl methacrylate.

Example low Tg heteroalkyl (meth)acrylate monomers often have at least 3 carbon atoms, at least 4 carbon atoms, or at least 6 carbon atoms and can have up to 30 or more carbon atoms, up to 20 carbon atoms, up to 18 carbon atoms, up to 16 carbon atoms, up to 12 carbon atoms, or up to 10 carbon atoms. Specific examples of heteroalkyl (meth)acrylates include, but are not limited to, 2-ethoxyethyl acrylate, 2-(2-ethoxyethoxy)ethyl acrylate, 2-methoxyethyl (meth)acrylate, and tetrahydrofurfuryl (meth)acrylate.

Exemplary aryl substituted alkyl acrylates or aryloxy substituted alkyl acrylates include, but are not limited to, 2-biphenylhexyl acrylate, benzyl acrylate, 2-phenoxyethyl acrylate, and 2-phenylethyl acrylate.

In some embodiments, the monomer composition contains at least 40 weight percent, at least 45 weight percent, at least 50 weight percent, at least 60 weight percent, at least 65 weight percent, at least 70 weight percent, or at least 75 weight percent and up to 100 weight percent, up to 99 weight percent, up to 98 weight percent, up to 95 weight percent, or up to 90 weight percent of the low Tg monomer. The amounts are based on the total weight of monomers in the monomer composition used to form the (meth)acrylic-based polymeric material.

Some monomer compositions can include an optional polar monomer. The polar monomer has an ethylenically unsaturated group plus a polar group such as an acidic groups or a salt thereof, a hydroxyl group, a primary amido group, a secondary amido group, a tertiary amido group, or an amino group. Having a polar monomer often facilitates adherence of the pressure-sensitive adhesive to a variety of substrates. Further, the polar monomers can provide functionality for reacting with various crosslinking agents. Still further, some polar monomers, such as those having an acidic group, may undergo complementary reactions (acid-base reactions) with the amide compounds that are blended with the (meth)acrylic-based polymeric material.

Exemplary polar monomers with an acidic group include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinyl phosphonic acid, and mixtures thereof Due to their availability, the acid monomers are often (meth)acrylic acids.

Exemplary polar monomers with a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide and 3-hydroxypropyl (meth)acrylamide), ethoxylated hydroxyethyl (meth)acrylate (e.g., monomers commercially available from Sartomer (Exton, Pa., USA) under the trade designation CD570, CD571, and CD572), and aryloxy substituted hydroxyalkyl (meth)acrylates (e.g., 2-hydroxy-2-phenoxypropyl (meth)acrylate).

Exemplary polar monomers with a primary amido group include (meth)acrylamide. Exemplary polar monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, or N-octyl (meth)acrylamide.

Exemplary polar monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

In some embodiments, the polar monomer has a hydroxyl group or carboxylic acid group. That is, some (meth)acrylic-based polymeric material have pendant carboxylic acid groups, pendant hydroxyl groups, or both. The pendant hydroxyl groups and/or carboxylic acid groups can function as reactive groups that can react with complementary groups in the crosslinking agents. Further, the carboxylic acid groups may interact with the amide compounds that are mixed with the (meth)acrylic-based polymeric material to form the pressure-sensitive adhesive layer.

The amount of polar monomer in the monomer composition is often in a range of 0 to 15 weight percent based on the weight of monomers in the monomer composition. Some polar monomers such as (meth)acrylic acid are considered to be high Tg monomers. Thus, if the amount of these monomers is too high, the resulting (meth)acrylic-based polymeric material may not have a Tg that is no greater than 20° C. If present, the amount of polar monomers in the monomer composition is often at least 0.1 weight percent, at least 0.5 weight percent, or at least 1 weight percent based on the total weight of monomers in the monomer composition. The amount can be up to 15 weight percent, up to 10 weight percent, or up to 5 weight percent. For example, the amount is often in a range of 0 to 10 weight percent, in a range of 0 to 5 weight percent, in a range of 0.5 to 15 weight percent, in a range of 1 to 15 weight percent, in a range of 5 to 15 weight percent, or in a range of 1 to 10 weight percent based on a total weight of monomers in the monomer composition.

The monomer composition can optionally include a high Tg monomer. As used herein, the term “high Tg monomer” refers to a monomer that has a Tg greater than 50° C. when homopolymerized (i.e., a homopolymer formed from the high Tg monomer has a glass transition temperature greater than 50° C.). Suitable high T_{g} monomers include, but are not limited to, methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, phenyl (meth)acrylate, cyclohexyl (meth)acrylate, isobornyl (meth)acrylate, benzyl (meth)acrylate, 3,3,5 trimethylcyclohexyl (meth)acrylate, and mixtures thereof.

The amount of optional high Tg monomer used to form the (meth)acrylic-based polymeric material can be up to 50 weight percent or even higher provided that the Tg of the (meth)acrylic-based polymeric material is no greater than 20° C. In some embodiments, the amount can be up to 40 weight percent, up to 30 weight percent, up to 20 weight percent, up to 15 weight percent, or up to 10 weight percent. If present, the amount can be at least 1 weight percent, at least 2 weight percent, or at least 5 weight percent. For example, the amount can be in a range of 0 to 50 weight percent, 0 to 40 weight percent, 0 to 30 weight percent, 0 to 20 weight percent, 0 to 10 weight percent, 1 to 30 weight percent, 1 to 20 weight percent, or 1 to 10 weight percent. The amounts are based on a total weight of monomers in the monomer composition.

The monomer composition can include optional vinyl monomers lacking a (meth)acryloyl group. That is, the vinyl monomer has an ethylenically unsaturated group that is not a (meth)acryloyl group. Examples of optional vinyl monomers include, but are not limited to, various vinyl ethers (e.g., vinyl methyl ether), vinyl esters (e.g., vinyl acetate and vinyl propionate), styrene, substituted styrene (e.g., α-methyl styrene), vinyl halide, and mixtures thereof The vinyl monomers having a polar group characteristic of polar monomers are considered herein to be polar monomers.

In some embodiments, a monomer such a vinyl acetate or a vinyl ether can be added to the monomer mixture but, due to its comparatively low reactivity, only a portion of the monomer ends up being incorporated (polymerized) into the (meth)acrylic-based polymeric material. For example, less than 70 percent, less than 60 percent, or less than 50 percent of the vinyl acetate and/or vinyl ether gets incorporated into the (meth)acrylic-based polymeric material. The remaining monomer can function as a solvent for the polymeric material.

The amount of the optional vinyl monomer lacking a (meth)acryloyl group is often in a range of 0 to 20 weight percent or more based on the weight of monomers in the monomer composition. If present, the amount of vinyl monomers in the monomer composition is often at least 0.1 weight percent, 0.2 weight percent, 0.5 weight percent, or 1 weight percent based on the total weight of monomers in the monomer composition. The amount can be up to 15 weight percent, up to 10 weight percent, or up to 5 weight percent. For example, the amount is often in a range of 0 to 20 weight percent, in a range of 0 to 15 weight percent, in a range of 0.1 to 15 weight percent, in a range of 0.5 to 15 weight percent, in a range of 1 to 15 weight percent, in a range of 1 to 10, or in a range of 1 to 5 based on a total weight of monomers in the monomer composition.

Overall the (meth)acrylic-based polymeric material can be formed from a monomer composition that includes up to 100 weight percent of the low Tg monomer. In some embodiments, the monomer composition contains 100 weight percent low Tg monomer based on the total weight of monomers in the monomer composition. In other embodiments, the monomer composition contains 40 to 100 weight percent of the low Tg monomer, 0 to 15 weight percent polar monomer, 0 to 50 weight percent high Tg monomer, and 0 to 20 weight percent vinyl monomers that do not include a (meth)acryloyl group. In still other embodiments, the monomer composition contains 60 to 100 weight percent of the low Tg monomer, 0 to 10 weight percent polar monomer, 0 to 40 weight percent high Tg monomer, and 0 to 15 weight percent vinyl monomers that do not include a (meth)acryloyl group. In yet other embodiments, the monomer composition contains 75 to 100 weight percent of the low Tg monomer, 0 to 10 weight percent polar monomer, 0 to 20 weight percent high Tg monomer, and 0 to 15 weight percent vinyl monomers that do not include a (meth)acryloyl group.

The resulting (meth)acrylic-based polymeric material contains up to 100 weight percent or 100 weight percent low Tg monomer units. The weight percent value is based on the total weight of monomeric units in the (meth)acrylic-based polymeric material. In some embodiments, the polymer contains 40 to 100 weight percent of the low Tg monomeric units, 0 to 15 weight percent polar monomeric units, 0 to 50 weight percent high Tg monomeric units, and 0 to 15 weight percent vinyl monomeric units. In still other embodiments, the polymer contains 60 to 100 weight percent of the low Tg monomeric units, 0 to 10 weight percent polar monomeric units, 0 to 40 weight percent high Tg monomeric units, and 0 to 15 weight percent vinyl monomeric units. In yet other embodiments, the polymer contains 75 to 100 weight percent of the low Tg monomeric units, 0 to 10 weight percent polar monomeric units, 0 to 20 weight percent high Tg monomeric units, and 0 to 15 weight percent vinyl monomeric units.

In addition to the monomer composition, the reaction mixture used to prepare the (meth)acrylic-based polymeric material typically includes a free radical initiator to commence polymerization of the monomers. The free radical initiator can be a photoinitiator or a thermal initiator. Suitable thermal initiators include various azo compound such as those commercially available under the trade designation VAZO from E. I. DuPont de Nemours Co. (Wilmington, Del., USA) including VAZO 67, which is 2,2′-azobis(2-methylbutane nitrile), VAZO 64, which is 2,2′-azobis(isobutyronitrile), VAZO 52, which is 2,2′-azobis(2,4-dimethylpentanenitrile), and VAZO 88, which is 1,1′-azobis(cyclohexanecarbonitrile); various peroxides such as benzoyl peroxide, cyclohexane peroxide, lauroyl peroxide, di-tert-amyl peroxide, tert-butyl peroxy benzoate, di-cumyl peroxide, and peroxides commercially available from Atofina Chemical, Inc. (Philadelphia, Pa.) under the trade designation LUPERSOL (e.g., LUPERSOL 101, which is 2,5-bis(tert-butylperoxy)-2,5-dimethylhexane, and LUPERSOL 130, which is 2,5-dimethyl-2,5-di-(tert-butylperoxy)-3-hexyne); various hydroperoxides such as tert-amyl hydroperoxide and tert-butyl hydroperoxide; and mixtures thereof.

Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Florham Park, N.J., USA) or under the trade designation ESACURE KB-1 from Sartomer (Exton, Pa., USA)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include, for example, 1-hydroxycyclohexyl phenyl ketone (commercially available under the trade designation IRGACURE 184), bis(2,4,6-trimethylbenzoyl)phenylphosphineoxide (commercially available under the trade designation IRGACURE 819), 1-[4-(2-hydroxyethoxy)phenyl]-2-hydroxy-2-methyl-1-propane-1-one (commercially available under the trade designation IRGACURE 2959), 2-benzyl-2-dimethylamino-1-(4-morpholinophenyl)butanone (commercially available under the trade designation IRGACURE 369), 2-methyl-1-[4-(methylthio)phenyl]-2-morpholinopropan-1-one (commercially available under the trade designation IRGACURE 907), and 2-hydroxy-2-methyl-1-phenyl propan-1-one (commercially available under the trade designation DAROCUR 1173 from Ciba Specialty Chemicals Corp. (Tarrytown, N.Y., USA).

The amount of the free radical initiator is often at least 0.01 weight percent, at least 0.05 weight percent, at least 0.1 weight percent, or at least 0.5 weight percent and can be up to 5 weight percent or higher, up to 3 weight percent, up to 2 weight percent, or up to 1 weight percent based on a total weight of monomers in the first monomer composition. The amount can be, for example, in a range of 0.01 to 5 weight percent, in a range of 0.01 to 2 weight percent, in a range of 0.01 to 1 weight percent, in a range of 0.05 to 1 weight percent, or in an range of 0.1 weight percent based on a total weight of the monomers present in the first monomer composition.

The reaction mixture may optionally further contain a chain transfer agent to control the molecular weight of the resultant (meth)acrylic-based polymeric tackifier. Examples of useful chain transfer agents include, but are not limited to, carbon tetrabromide, alcohols (e.g., isopropanol), mercaptans or thiols (e.g., lauryl mercaptan, butyl mercaptan, ethanethiol, isooctylthioglycolate, 2-ethylhexyl thioglycolate, 2-ethylhexyl mercaptopropionate, ethyleneglycol bisthioglycolate, and tertiary dodecyl mercaptan), and mixtures thereof. In some embodiments where a chain transfer agent is used that is not an alcohol, the polymerizable mixture often includes up to 2 weight percent, up to 1 weight percent, up to 0.5 weight percent, up to 0.2 weight percent, or up to 0.1 weight percent transfer agent based on a total weight of monomers. If the chain transfer agent is an alcohol, however, the amount of chain transfer agent in the polymerizable mixture can be up to 5 weight percent, up to 10 weight percent, or up to 20 weight percent. If a chain transfer agent is present, the reaction mixture can contain at least 0.005 weight percent, at least 0.01 weight percent, at least 0.02 weight percent, or at least 0.05 weight percent of the chain transfer agent based on the total weight of monomers.

The polymerization of the reaction mixture optionally can occur in the presence of an organic solvent. If an organic solvent is included in the polymerizable mixture, the amount is often selected to provide the desired viscosity. Any desired amount of organic solvent can be used. For example, the amount can be up to 50 weight percent or more, up to 40 weight percent, up to 30 weight percent, up to 20 weight percent, or up to 10 weight percent of the reaction mixture. In some embodiments, the polymerization occurs with little or no organic solvent present. That is the reaction mixture is free of organic solvent or contains a minimum amount of organic solvent such as less than 10 weight percent, less than 5 weight percent, less than 4 weight percent, less than 3 weight percent, less than 2 weight percent, or less than 1 weight percent based on the total weight of the reaction mixture used to form the (meth)acrylic-based polymeric material. Examples of suitable organic solvents include, but are not limited to, methanol, tetrahydrofuran, ethanol, isopropanol, heptane, acetone, methyl ethyl ketone, methyl acetate, ethyl acetate, toluene, xylene, and ethylene glycol alkyl ether. Those solvents can be used alone or as mixtures thereof.

The reaction mixture can be polymerized using any suitable method. The polymerization can occur in a single step or in multiple steps. That is, all or a portion of the monomers and/or thermal initiator may be charged into a suitable reaction vessel and polymerized. For example, a reaction mixture containing an organic solvent and a thermal initiator can be mixed and heated at an elevated temperature such as in a range of 50° C. to 100° C. for several hours.

In some embodiments, the (meth)acrylic-based polymeric material is prepared using an adiabatic process as described, for example, in U.S. Pat. No. 5,986,011 (Ellis et al.) and U.S. Pat. No. 5,637,646 (Ellis). In this polymerization method, the reaction components, including thermal initiator or initiators, are sealed in a reaction vessel. The contents are mixed and purged of oxygen and, if not already at induction temperature, then warmed to the induction temperature. The induction temperature, which is usually in the range of 40° C. to 75° C., depends on various factors such as the monomers, the initiator, and amount of the initiator used. The polymerization is performed under essentially adiabatic conditions with a peak reaction temperature in the range of 100° C. to 200° C. Multiple reaction steps with optional cooling in between steps can be employed to increase polymerization conversion on each successive step and to control the molecular weight. Optionally, various reaction components can be added in multiple steps to control the properties (e.g., molecular weight, molecular weight distribution, and polymer composition) of the resulting polymeric material.

The weight average molecular weight of the elastomeric (meth)acrylic-based polymeric material is often in a range of 300,000 Da to 2,000,000 Da. For example, the weight average molecular weight can be at least 400,000 Da, at least 500,000 Da, or at least 600,000 Da and can be up to 2,000,000 Da, up to 1,500,000 Da, up to 1,000,000 Da, up to 900,000 Da, up to 800,000 Da, or up to 70,000 Da.

### Amide Compound

The pressure-sensitive adhesive composition includes an amide compound, which is referred to herein interchangeably as a “fatty amide compound”, is of formula R¹—(CO)NH—R² that has a melting point in a range of 80° C. to 140° C. The group R¹ is an alkyl or alkenyl groups having at least 11 carbon atoms and the group R² is hydrogen or an alkyl.

Suitable R¹ alkyl groups and alkenyl groups often have at least 12 carbon atoms, at least 14 carbon atoms, or at least 16 carbon atoms and can have up to 30 carbon atoms, up to 26 carbon atoms, up to 24 carbon atoms, up to 22 carbon atoms, up to 20 carbon atoms, or up to 18 carbon atoms. Suitable R² alkyl groups often have 1 to 10 carbon atoms, 1 to 6 carbon atoms, or 1 to 4 carbon atoms. In some embodiments, R² is hydrogen or methyl.

Suitable amide compounds are fatty amide compounds have a melting point in a range of 80° C. to 140° C. If the melting point is greater than about 140° C., the amide compound can be difficult to dissolve in a suitable solvent for blending with the (meth)acrylic-based polymeric material. Further, if the melting point is less than about 80° C., the amide compound may not crystallize on the surface of the pressure-sensitive adhesive layer. In some embodiments, the melting point of the amide compound is at least 80° C., at least 81° C., at least 85° C., at least 90° C., or at least 100° C. and up to 140° C., up to 130° C., up to 120° C., or up to 110° C. The melting point can be measured by heating the compounds and observing the temperature when melting occurs. Alternatively, methods such as Differential Scanning calorimetry can be used to measure the melting point.

Example amide compounds include, but are not limited to, saturated fatty amides such as lauramide, palmitamide, stearamide, and behenamide as well as unsaturated fatty amides such as erucylamide. In many embodiments, the pressure-sensitive adhesive composition is free of fatty acids and bis-fatty acids and bis-fatty amides. In other embodiment, small amounts of other optional fatty compounds can be present along with the fatty amide compound such as fatty acid compounds, bis-fatty acid compounds, bis-fatty amide compounds, or a mixture thereof. For example, the amount of these other compounds can be present in an amount in a range of 0 to 25 weight percent, in a range of 0 to 20 weight percent, in a range of 0 to 15 weight percent, in a range of 0 to 10 weight percent, or in a range of 0 to 5 weight percent based on the weight of the fatty amine compound. Some of these other compounds are difficult to dissolve and/or have a melting point outside of the desired range.

In one method of blending the fatty amide compound with the (meth)acrylic-based polymeric material, a solution of the fatty amide compound is prepared and mixed with the (meth)acrylic-based polymeric material that has been fully formed. The fatty amide is usually dissolved in an organic solvent or organic solvent mixture that dissolves both the (meth)acrylic-based polymeric material and the fatty amide compound. Suitable solvents include, but are not limited to, toluene, ethyl acetate, tetrahydrofuran, dimethyl formamide, acetonitrile, dimethyl sulfoxide, and acetone. In some embodiments, one of more of these solvents can be mixed with an alcohol such as methanol, ethanol, or isopropanol. For example, the mixture can include up to 20 volume percent, up to 15 volume percent, up to 10 volume percent, or up to 5 volume percent of the alcohol. The components of the solution often are mixed for several hours or more at room temperature to ensure complete dissolution. The solution containing the dissolved (meth)acrylic-based polymeric material and the dissolved fatty amide compound often contains 0.1 to 5 parts fatty amide per 100 parts of the (meth)acrylic-based polymeric material. For example, the amount of fatty amide compound can be at least 0.1 phr (parts per hundred of the resin), at least 0.2 phr, at least 0.3 phr, at least 0.5 phr, or at least 1 phr and up to 5 phr, up to 4 phr, up to 3 phr, or up to 2 phr.

Alternatively, the fatty amide compound can be mixed with the monomer composition used to form the (meth)acrylic-based polymeric material. That is, the fatty amide compound can be present when the (meth)acrylic-based polymeric material is prepared. The reaction mixture often contains the monomers described above for preparing the (meth)acrylic-based polymeric material, the fatty amide compound, and organic solvent. The amount of organic solvent can be, for example, up to 60 weight percent or more, up to 50 weight percent, up to 40 weight percent, up to 30 weight percent, and at least 5 weight percent, at least 10 weight percent, at least 20 weight percent, or at 25 weight percent based on the total weight of the reaction mixture. The amount of the fatty amide in the reaction mixture is usually 0.1 to 5 parts per 100 parts of the monomers used to form the (meth)acrylic-based polymeric material. After polymerization, the amount of fatty amide compound can be at least 0.1 phr (parts per hundred of the resin), at least 0.2 phr, at least 0.3 phr, at least 0.5 phr, or at least 1 phr and up to 5 phr, up to 4 phr, up to 3 phr, or up to 2 phr. Preparing the (meth)acrylic-based polymeric material in the presence of the fatty amide compound can have manufacturing advantages.

### Optional Crosslinking Agent

A coating composition is prepared that includes a solution containing dissolved (meth)acrylic-based polymeric material and dissolved fatty amide compound in an organic solvent. In some embodiments, the coating composition includes other optional compounds such as, for example, a chemical crosslinking agent.

Any known crosslinking agent can be used. In some embodiments, the crosslinking agent is selected to react with various pendant groups on the (meth)acrylic-based polymeric material. That is, the crosslinking agent has two or more reactive groups that can react with complementary reactive pendant groups on the (meth)acrylic-based polymeric material.

For example, a crosslinking agent having two or more aziridine groups can react with pendant groups carboxylic acid groups on the (meth)acrylic-based polymeric material. Such crosslinking agents are described in U.S. Pat. No. 8,507,612 (Zhu et al.) and in an article by Zbigniew Czech in International Journal of Adhesion and Adhesives, 27 (1), pages 49-58, January 2007. Some specific examples of aziridine crosslinkers are N,N′-bis-propylenadipic acid amide (BPA) and 1,1′-isophthaloyl-bis-1-methylaziridine (C.A.S. 7652-64-4). Methods of making aziridine crosslinkers are described, for example, in U.S. Pat. No. 8,507,612 (Zhu et al.).

In yet another example, a crosslinking agent can be a multifunctional isocyanate (i.e., the crosslinking agent has a plurality of isocyanato groups) that can react with a (meth)acrylic-based polymeric material having either pendant hydroxyl groups or pendant amine groups (primary or secondary amine groups). An example isocyanate crosslinking agent is commercially available under the trade designation DESMODUR (e.g., DESMODUR L-75 from Bayer (Cologne, Germany). This crosslinking method is further described, for example, in PCT Application Publication WO 2010/040014 (Everaerts et al.).

In still another example, a crosslinking agent can be a multifunctional (meth)acrylate (i.e., the crosslinking agent has a plurality of (meth)acryloyl groups) that can react with a (meth)acrylic-based polymeric material having pendant (meth)acryloyl groups. The pendant (meth)acryloyl groups on the (meth)acrylic-based polymeric material can be formed by reacting a (meth)acrylic-based polymeric material having pendant hydroxyl groups with a (meth)acrylate monomer having an isocyanato group (e.g., isocyanato ethyl methacrylate) or with a (meth)acrylate monomer having an epoxy group (e.g., glycidyl methacrylate). Example multifunctional (meth)acrylate crosslinking agents include, but are not limited to, 2-ethanediol diacrylate, 1,3-propanediol diacrylate, 1,4-butanediol diacrylate, 1,4-butanediol diacrylate, and 1,6-hexanediol diacrylate (HDDA). With this approach, an initiator is often added in addition to the multifunctional (meth)acrylate crosslinking agent. This crosslinking method is further described, for example, in PCT Application Publication WO 2014/4078115 (Behling et al.).

In another example, a crosslinking agent can be an ionic crosslinker such as a metal chelating agent. The metal chelates can react with a (meth)acrylic-based polymeric material having pendant carboxylic acid groups. Suitable metal chelates are often metal acetylacetonates. The metal can be, for example, aluminum, titanium, zinc, or iron. These types of crosslinkers are further described, for example, in U.S. Patent Application Publication 2011/0104486 (Ma et al.).

The optional crosslinking agent is often used in an amount of 0 to 5 parts or 0.01 to 5 parts per100 parts of the (meth)acrylic-based polymeric material. In some embodiments, the amount is at least 0.01 phr, at least 0.02 phr, at least 0.05 phr, at least 0.1 phr, or at least 0.5 phr, or at least 1 phr and up to 5 phr, up to 4 phr, up to 3 phr, up to 2 phr, or up to 1 phr.

### Optional Tackifier

The coating composition, which includes the solution containing dissolved (meth)acrylic-based polymeric material and dissolved fatty amide compound in an organic solvent, can optionally further include a tackifier. Any known tackifiers (i.e., tackifying resins) for pressure-sensitive adhesive compositions may be suitable. The tackifier is typically selected to be soluble and compatible in the coating composition. As used with reference to the tackifier and the coating composition, the term “compatible” means that the coating composition containing the tackifier is a single phase.

Examples of suitable tackifying resins include rosin resins such as rosin acids and their derivatives (e.g., rosin esters); terpene resins such as polyterpenes (e.g., alpha pinene-based resins, beta pinene-based resins, and limonene-based resins) and aromatic-modified polyterpene resins (e.g., phenol modified polyterpene resins); coumarone-indene resins; and petroleum-based hydrocarbon resins such as CS-based hydrocarbon resins, C9-based hydrocarbon resins, C5/C9-based hydrocarbon resins, and dicyclopentadiene-based resins. These tackifying resins, if added, can be hydrogenated to lower their color contribution to the pressure-sensitive adhesive composition. Combinations of various tackifiers can be used, if desired.

Other examples of suitable tackifying resins are (meth)acrylic-based polymeric tackifiers. The (meth)acrylic-based polymeric tackifiers are not elastomeric and have a higher glass transition temperature than the (meth)acrylic-based polymeric materials described above. For example, the (meth)acrylic-based polymeric tackifiers typically have a glass transition temperature equal to at least 50° C. The glass transition temperature can be determined using methods such as Differential Scanning Calorimetry or Dynamic Mechanical Analysis. Alternatively, the glass transition temperature can be estimated using the Fox equation. Suitable (meth)acrylic-based polymeric tackifiers are described, for example, in U.S. Pat. No. 9,290.682 (Chen et al.).

In some articles, the use of tackifiers that are clear to the human eye may be desirable. In such articles, the tackifiers are often hydrogenated hydrocarbon tackifiers or (meth)acrylic based polymeric tackifiers.

The optional tackifying resin can be used in an amount in a range of 0 to 150 parts per 100 parts of the (meth)acrylic-based polymeric material. The amount can be at least 10 phr, at least 20 phr, at least 40 phr, or at least 50 phr and can be up to 80 phr, up to 100 phr, up to 120 phr, or up to 150 phr.

### Other Optional Components

Other optional additives can be added to the mixture containing the (meth)acrylic-based polymeric material, the amide compound, and organic solvent. In some embodiments, the mixture can further include a filler (e.g., fibers, pigments, carbon black, silica (including fumed silica and silica nanoparticles), and the like), an antioxidant, a UV-stabilizer, plasticizers, or mixtures thereof.

### Method of Making Adhesive Article

A method of making an adhesive article is provided. The method includes forming a coating composition containing a solution that includes 1) a (meth)acrylic-based polymeric material and 2) an amide compound of formula R¹—(CO)NH—R² having a melting point in a range of 80° C. to 140° C. The group R¹ is an alkyl or alkenyl groups having at least 11 carbon atoms thereof and the group R² is hydrogen or alkyl. The method further includes positioning a layer of the mixture adjacent to a first substrate. The method still further includes drying the mixture to form a pressure-sensitive adhesive layer adjacent to the first substrate, wherein a surface of the pressure-sensitive adhesive layer opposite the first substrate contains crystalline material comprising the amide compound.

The mixture that is coated is often a solution that contains the (meth)acrylic-based polymeric material, the amide compound, and an organic solvent. In some embodiments, the mixture includes other optional components as described above. Any suitable percent solids can be used. In some embodiments, the percent solids are in a range of 10 to 60 weight percent. If the percent solids are too high, the viscosity of the coating solution may be unacceptably high when applied to a surface of the first substrate. If the percent solids are too low, however, the time and energy needed to remove the organic solvent may be unacceptable. The percent solids are often at least 10 weight percent, at least 20 weight percent, at least 30 weight percent, or at least 35 weight percent and can be up to 40 weight percent, up to 45 weight percent, up to 50 weight percent, up to 55 weight percent, or up to 60 weight percent.

The (meth)acrylic-based polymeric material is often fully formed prior to combination with the amide compound. In some embodiments, however, the amide compound is combined with the monomers used to form the (meth)acrylic-based polymeric material rather than the fully formed (meth)acrylic-based polymeric material. The monomers can be polymerized in the presence of the amide compound. Regardless of when the amide compound, is added the (meth)acrylic-based polymeric material and the amide compound form a solution.

The mixture containing the solution of dissolved (meth)acrylic-based polymer and dissolved amide compound is positioned adjacent to a first substrate. The first substrate can be flexible or inflexible and can be formed, for example, from paper, polymeric material, glass or ceramic material, metal, or combination thereof. Some substrates are polymeric materials such as those prepared from polyolefins (e.g., polyethylene, polypropylene, or copolymers thereof), polyurethanes, polyvinyl acetates, polyvinyl chlorides, polyesters (polyethylene terephthalate or polyethylene naphthalate), polycarbonates, poly(meth)acrylic-based polymers (e.g., poly(methyl methacrylate), ethylene-vinyl acetate copolymers, and cellulosic materials (e.g., cellulose acetate, cellulose triacetate, and ethyl cellulose). In some embodiments, the polymeric material is a thermoplastic film. In other embodiments, the polymeric material is a foam with open or closed cells.

It may be desirable to treat the surface of the first substrate to improve adhesion to the coating mixture. Such treatments include, for example, application of primer layers, surface modification layer (e.g., corona treatment or surface abrasion), or both.

Any known method of positioning a layer of the mixture on the first substrate can be used. Example methods include flow coating, dip coating, spray coating, knife coating, die coating, or extrusion. After positioning the mixture on the first substrate, the coated layer is often dried to remove the organic solvent. The removal of organic solvent can occur at any suitable temperature. The temperature is often dependent on the organic solvents included in the coating mixture. In some embodiments, the temperature is in a range of room temperature to 150° C. or higher depending on the particular organic solvent used in the mixture. For example, the temperature is in a range of room temperature (about 20° C. to 25° C.) to 150° C., in a range of 40° C. to 150° C., in a range of 40° C. to 120° C., in a range of 40° C. to 100° C., or in a range of 40° C. to 80° C. Higher drying temperatures may facilitate movement of the amide compound within the drying coated layer and formation of crystals of the amide compound on a surface of the coated layer opposite the first substrate. In some methods, the coated layer is passed through a drying oven that has various zone set at different temperatures. For example, the first zones are typically set at lower temperatures than subsequent zones. Further, the dried coated layer can be held at elevated temperatures for any desired amount of time to increase the rate of crystal formation.

The dried coated layer is a pressure-sensitive adhesive layer. In some embodiments, the pressure-sensitive adhesive layer is exposed to an optional electron beam radiation or gamma ray radiation. That is, electron beam radiation can be used in place of or in addition to a chemical crosslinking agent to increase the cohesive strength of the pressure-sensitive adhesive layer. Typically, the amount of radiation is in a range of 1 to 20 Mrads of electron beam radiation or 10 to 200 kilogray gamma ray radiation. For example, the dosage of electron beam radiation can be at least 1 Mrad, at least 2 Mrads, at least 4 Mrads, or at least 8 Mrads and can be up to 20 Mrads, up to 16 Mrads, or up to 12 Mrads. The dosage of gamma ray radiation can be at least 10 kilogray, at least 20 kilogray, at least 40 kilogray, at least 80 kilogray and can be up to 200 kilogray, up to 160 kilogray, or up to 120 kilogray. These crosslinking methods can advantageously remove the need for chemical crosslinkers.

If desired, the pressure-sensitive adhesive layer can be laminated to a release liner to protect the pressure-sensitive adhesive layer until it is used. That is, the resulting article includes a release liner, pressure-sensitive adhesive layer, and a first substrate. There is crystalline material located between the release liner and the pressure-sensitive adhesive layer. When ready to be applied to a second substrate, the release liner can be separated from the pressure-sensitive adhesive layer. The second substrate can be prepared from any desired material and can have desired size and shape. In some embodiments, the second substrate can be prepared of any of the materials described above for use as the first substrate.

### Adhesive Articles

Adhesive articles are provided that include a first substrate and a pressure-sensitive adhesive layer positioned adjacent to the first substrate. The pressure-sensitive adhesive comprises a (meth)acrylic-based polymeric material and crystalline material on a surface of the pressure-sensitive adhesive layer opposite the first substrate. The crystalline material contains the amide compound.

In many embodiments, the crystalline material covers from 1 to 90 percent of the geometric surface area (i.e., the area defined by the dimensions of the surface) of the pressure-sensitive adhesive layer opposite the first substrate (e.g., the backing layer). If coverage area is too high, the peel adhesion may be insufficient. If the coverage area is too low, however, the addition of the amide compound is not effective in lowering the tackiness of the surface. The resulting adhesive article may be difficult to move or reposition. In some embodiment, at least 1 percent, at least 2 percent, at least 4 percent, at least 5 percent, at least 10 percent, at least 20 percent, at least 30 percent and up to 90 percent, up to 80 percent, up to 75 percent, up to 70 percent, up to 60 percent, or up to 50 percent of the geometric surface area of the pressure-sensitive adhesive is covered with crystalline materials of the amide compound. The coverage can be determined using atomic force microscopy techniques as described below.

The crystalline materials on the surface of the pressure-sensitive adhesive layer often have an average length (i.e., the longest dimension) in a range of 1 to 30 micrometers. For example, the crystalline materials can have an average length of at least 1 micrometer, at least 2 micrometers, at least 5 micrometers, or at least 10 micrometers. The average length can be up to 30 micrometers or greater, up to 25 micrometers, up to 20 micrometers, or up to 15 micrometers. The average length can be determined using atomic force microscopy techniques as described below.

The crystalline materials on the surface of the pressure-sensitive adhesive layer often have an average breadth (i.e., width, the shortest dimension) in a range of 0.3 to 10 micrometers. For example, the crystalline materials can have an average width of at least 0.3 micrometer, at least 0.5 micrometer, at least 1 micrometer, at least 2 micrometers, or at least 3 micrometers. The average width can be up to 10 micrometers, up to 8 micrometers, up to 6 micrometers, or up to 4 micrometers.

The presence of the crystalline materials on the surface of the pressure-sensitive adhesive layer advantageously provide a surface that has low tackiness but that has good peel adhesion. For example, in some embodiments the tackiness, as measured using the probe tack test described below, is in a range of 50 to 500 megaPascals (MPa). For example, the probe tack value can be at least 50 MPa, at least 75 MPa, at least 100 MPa, at least 125 MPa, at least 150 MPa, or at least 200 MPa, and can be up to 500 MPa, up to 450 MPa, up to 400 MPa, up to 350 MPa, or up to 300 MPa.

The 180 degree peel adhesion of the pressure-sensitive adhesive layer at room temperature with a 20 minute dwell time or more is often at least 35 Newtons/decimeter (N/dm), at least 40 N/dm, at least 50 N/dm, at least 60 N/dm, or at least 65 N/dm. The 180 degree peel adhesion is often at least 100 N/dm, at least 110 N/dm, or at least 120 N/dm after a dwell time of 4 hours at 65° C. Stated differently, the 180 degree peel adhesion of the pressure-sensitive adhesive layer at room temperature with a 20 minute dwell time or more is often at least 1000 grams/25 mm, at least 1040 grams/25 mm, at least 1300 grams/25 mm, at least 1560 grams/25 mm, or at least 1690 grams/25 mm. Similarly, the 180 degree peel adhesion is often at least 2600 grams/25 mm, at least 2860 grams/25 mm, or at least 3120 grams/25 mm after a dwell time of 4 hours or more at 65° C.

Various embodiments are provided that include an adhesive article and a method of making the adhesive article.

Embodiment 1A is an adhesive article that includes a first substrate and a pressure-sensitive adhesive layer positioned adjacent to the first substrate. The pressure-sensitive adhesive contains a (meth)acrylic-based polymeric material and crystalline material on a surface of the pressure-sensitive adhesive layer opposite the first substrate. The crystalline material includes an amide compound of formula R¹—(CO)NH—R² that has a melting point in a range of 80° C. to 140° C. The group R¹ is an alkyl or alkenyl groups having at least 11 carbon atoms and the group R² is hydrogen or an alkyl.

Embodiment 2A is the adhesive article of embodiment 1A, wherein the crystalline materials comprise lauramide, palmitamide, stearamide, behenamide, erucylamide, or a mixture thereof.

Embodiment 3A is the adhesive article of embodiment 1A or 2A, wherein the pressure-sensitive adhesive layer comprises 0.1 to 5 parts of the amide compound per 100 parts of the (meth)acrylic-based polymeric material.

Embodiment 4A is the adhesive article of any one of embodiments 1A to 3A, wherein the crystalline materials cover 1 to 90 percent of the geometric surface area of the pressure-sensitive adhesive layer opposite the first substrate.

Embodiment 5A is the adhesive article of embodiment 4A, wherein the crystalline material cover 2 to 75 percent of the geometric surface area of the pressure-sensitive adhesive layer opposite the first substrate.

Embodiment 6A is the adhesive article of any one of embodiments 1A to 5A, wherein the crystalline material has an average length in a range of 1 to 30 micrometers.

Embodiment 7A is the adhesive article of any one of embodiments 1A to 6A, wherein the crystalline material has an average breadth (width) in a range of 0.3 to 10 micrometers.

Embodiment 8A is the adhesive article of any one of embodiments 1A to 7A, wherein the (meth)acrylic-based polymeric material is crosslinked.

Embodiment 9A is the adhesive article of any one of embodiments 1A to 8A, wherein the (meth)acrylic-based polymeric material has 1 to 15 weight percent polar monomeric units.

Embodiment 10A is the adhesive article of embodiment 9A, wherein the polar monomeric units have a pendant hydroxyl group or a pendant carboxylic acid group.

Embodiment 11A is the adhesive article of any one of embodiments 1A to 10A, wherein the (meth)acrylic-based polymeric material has a Tg no greater than 20° C.

Embodiment 12A is the adhesive article of any one of embodiments 1A to 11A, wherein the (meth)acrylic-based polymeric material is a polymerized product of a monomer composition comprising 40 to 100 weight percent of low Tg monomer (i.e., a monomer having a Tg no greater than 20° C. when homopolymerized), 0 to 15 weight percent polar monomer, 0 to 50 weight percent high Tg monomer (i.e., a monomer having a Tg greater than 50° C. when homopolymerized), 0 to 20 weight percent vinyl monomers that do not have a (meth)acryloyl group.

Embodiment 13A is the adhesive article of any one of embodiments 1A to 12A, wherein the (meth)acrylic-based polymeric material has a weight average molecular weight in a range of 300,000 Da to 2,000,000 Da.

Embodiment 14A is the adhesive article of any one of embodiments 1A to 13A, wherein the pressure-sensitive adhesive layer further comprises a tackifier.

Embodiment 15A is the adhesive article of embodiment 14A, wherein the tackifier is present in an amount in range of 0 to 150 parts per 100 parts of the (meth)acrylic-based polymeric material.

Embodiment 16A is the adhesive article of any one of embodiments 1A to 15A, wherein the first substrate comprises a polymeric material.

Embodiment 17A is the adhesive article of embodiment 16A, wherein the polymeric material is a thermoplastic material.

Embodiment 18A is the adhesive article of embodiment 17A, wherein the thermoplastic material is a film.

Embodiment 19A is the adhesive article of embodiment 17A or 18A, wherein the thermoplastic material comprises polyurethane.

Embodiment 20A is the adhesive article of any one of embodiments 1A to 19A, wherein the tackiness of the surface of the pressure-sensitive adhesive opposite the first substrate has a tackiness in a range of 50 to 500 MPa as measured using the probe test described below.

Embodiment 21A is the adhesive article of any one of embodiment 1A to 20A, wherein the pressure-sensitive adhesive layer has a 180 degree peel adhesion at room temperature with a dwell time or 20 minutes or more that is at least 35 Newtons/decimeter (which is equivalent to 1000 grams/25 mm).

Embodiment 22A is the adhesive article of any one of embodiments 1A to 21A, wherein the adhesive article further comprises a release liner laminated to the surface of the pressure-sensitive adhesive layer opposite the first substrate.

Embodiment 23A is the adhesive article of any one of embodiments 1A to 21A, wherein the adhesive article further comprises a second substrate adhered to the surface of the pressure-sensitive adhesive layer opposite the first substrate.

Embodiment 1B a method of making an adhesive article. The method includes forming a mixture containing a solution that includes 1) a (meth)acrylic-based polymeric material and 2) an amide compound of formula R¹—(CO)NH—R² having a melting point in a range of 80° C. to 140° C. The group R¹ is an alkyl or alkenyl groups having at least 11 carbon atoms thereof and the group R² is hydrogen or alkyl. The method further includes positioning a layer of the mixture adjacent to a first substrate. The method still further includes drying the mixture to form a pressure-sensitive adhesive layer adjacent to the first substrate, wherein a surface of the pressure-sensitive adhesive layer opposite the first substrate contains crystalline material that includes the amide compound.

Embodiment 2B is the method of embodiment 1B, wherein forming the mixture comprises combining the (meth)acrylic-based polymeric material (fully formed), the amide compound, and an organic solvent.

Embodiment 3B is the method of embodiment 1B, wherein forming the mixture comprises forming the (meth)acrylic-based polymeric material in the presence of the amide compound and an organic solvent.

Embodiment 4B is the method of any one of embodiments 1B to 3B, wherein drying the mixture to form the pressure-sensitive adhesive occurs at a temperature in a range of room temperature to 150° C. or in a range of 40° C. to 150° C.

Embodiment 5B is the method of any one of embodiments 1B to 4B, wherein the amide compound comprises lauramide, palmitamide, stearamide, behenamide, erucylamide, or a mixture thereof.

Embodiment 6B is the method of any one of embodiment 1B to 5B, wherein the pressure-sensitive adhesive layer comprises 0.1 to 5 parts of the amide compound per 100 parts of the (meth)acrylic-based polymeric material.

Embodiment 7B is the method of any one of embodiments 1B to 6B, wherein the crystalline materials cover 1 to 90 percent of the geometric surface area of the pressure-sensitive adhesive layer opposite the first substrate.

Embodiment 8B is the method of any one of embodiments 1B to 7B, wherein the crystalline material cover 2 to 75 percent of the geometric surface area of the pressure-sensitive adhesive layer opposite the first substrate.

Embodiment 9B is the method of any one of embodiments 1B to 8B, wherein the crystalline material has an average length in a range of 1 to 30 micrometers.

Embodiment 10B is the method of any one of embodiments 1B to 9B, wherein the crystalline material has an average breadth (width) in a range of 0.3 to 10 micrometers.

Embodiment 11B is the method of any one of embodiments 1B to 10B, wherein the method further comprises crosslinking the (meth)acrylic-based polymeric material.

Embodiment 12B is the method of any embodiment 11B, wherein crosslinking the (meth)acrylic-based polymeric material comprises exposing the layer of the mixture and/or the pressure-sensitive adhesive layer to electron beam radiation.

Embodiment 13B is the method of embodiment 11B, wherein crosslinking the (meth)acrylic-based polymeric material comprises adding a chemical crosslinker to the mixture.

Embodiment 14B is the method of any one of embodiment 1B to 13B, wherein the (meth)acrylic-based polymeric material has 1 to 15 weight percent polar monomeric units.

Embodiment 15B is the method of embodiment 14B, wherein the polar monomeric units have a pendant hydroxyl group or a pendant carboxylic acid group.

Embodiment 16B is the method of any one of embodiments 1B to 15B, wherein the (meth)acrylic-based polymeric material has a Tg no greater than 20° C.

Embodiment 17B is the method of any one of embodiments 1B to 16B, wherein the (meth)acrylic-based polymeric material is a polymerized product of a monomer composition comprising 40 to 100 weight percent of low Tg monomer (i.e., a monomer having a Tg no greater than 20° C. when homopolymerized), 0 to 15 weight percent polar monomer, 0 to 50 weight percent high Tg monomer (i.e., a monomer having a Tg greater than 50° C. when homopolymerized), 0 to 20 weight percent vinyl monomers that do not have a (meth)acryloyl group.

Embodiment 18B is the method of any one of embodiments 1B to 17B, wherein the (meth)acrylic-based polymeric material has a weight average molecular weight in a range of 300,000 Da to 2,000,000 Da.

Embodiment 19B is the method of any one of embodiments 1B to 17B, wherein the mixture further comprises a tackifier.

Embodiment 20B is the method of embodiment 19B, wherein the tackifier is present in an amount in range of 0 to 150 parts per 100 parts of the (meth)acrylic-based polymeric material.

Embodiment 21B is the method of any one of embodiments 1B to 20B, wherein the first substrate comprises a polymeric material.

Embodiment 22B is the method of embodiment 21B, wherein the polymeric material is a thermoplastic material.

Embodiment 23B is the method of embodiment 22B, wherein the thermoplastic material is a film.

Embodiment 24B is the method of embodiment 22B or 23B, wherein the thermoplastic material comprises polyurethane.

Embodiment 25B is the method of any one of embodiments 1B to 24B, wherein the tackiness of the surface of the pressure-sensitive adhesive opposite the first substrate has a tackiness in a range of 50 to 500 MPa as measured using the probe test described below.

Embodiment 26B is the method of any one of embodiments 1B to 25B, wherein the pressure-sensitive adhesive layer has a 180 degree peel adhesion at room temperature with a dwell time or 20 minutes or more that is at least 35 Newtons/decimeter (which is equivalent to 1000 grams/25 mm).

Embodiment 27B is the method of any one of embodiments 1B to 26B, further comprising adhering the surface of the pressure-sensitive adhesive layer opposite the first substrate to a second substrate.

Embodiment 28B is the method of any one of embodiments 1B to 26B, further comprising laminating the surface of the pressure-sensitive adhesive layer opposite the first substrate to a release liner.

### EXAMPLES

TABLE 1
Raw materials used in preparing examples and comparative examples

| Description | Source |
|---|---|
| Stearamide (SAM) | TCI America, Portland, OR |
| Oleamide (OAM) | TCI America, Portland, OR |
| Lauramide (LAM) | TCI America, Portland, OR |
| Erucamide (EAM) | TCI America, Portland, OR |
| Behenamide (BAM) | TCI America, Portland, OR |
| Vinyl acetate (VOAc) | Celanese LTD, Irving, TX |
| Acrylic acid (AA) | BASF, Florham Park, NJ |
| Ethylhexyl acrylate (EHA) | BASF, Florham Park, NJ |
| Azobis(2-methylbutyronitrile) | DuPont, Wilmington, DE |
| (VAZO 67) | |
| Isopropyl alcohol (IPA) | Brenntag, St. Paul, MN |
| Ethyl acetate (EtOAc) | Solvay USA, Inc., Cincinnati, OH |
| Heptane | ExxonMobile, Inc., Irving, TX |
| 1,1′-Isophthaloyl-bis-1-methyl- | (CAS No. 7652-64-4) |
| aziridine (BISAMIDE-1) | |

### Test Methods

### Melting Point of Amide Compound by DSC

Differential scanning calorimetry (DSC) was performed on a TA Instruments Inc. (New Castle, Del.) Q2000 model. DSC samples were typically 6 to 10 milligrams. Testing was done in sealed, aluminum, T-zero sample pans, heating at a rate of 10° C./min from 20° C. to 200° C. The data from the melting process was graphed on a chart showing heat flow versus temperature. The peak temperature of the endotherm profile represents the melting point of the amide compound. Melting points of typical amide compounds used in this invention was listed in Table 3.

TABLE 2
Material characteristics of amide compounds

| | Melting Point, | Chemical | Molecular Weight, |
|---|---|---|---|
| Name | ° C. | Formula | g/mol |
| OAM | 72.9 | C₁₇H₃₃CONH₂ | 281.5 |
| EAM | 84.4 | C₂₁H₄₁CONH₂ | 337.6 |
| LAM | 100.9 | C₁₁H₂₃CONH₂ | 199.3 |
| SAM | 109.5 | C₁₇H₃₅CONH₂ | 283.5 |
| BAM | 111.1 | C₂₁H₄₃CONH₂ | 339.6 |

### Polymer Molecular Weight Measurement

The molecular weight distribution of the polymeric materials was characterized using gel permeation chromatography (GPC). The GPC instrumentation, which was obtained from Waters Corporation (Milford, Mass., USA), included a high pressure liquid chromatography pump (Model 1515HPLC), an auto-sampler (Model 717), a UV detector (Model 2487), and a refractive index detector (Model 2410). The chromatograph was equipped with two 5 micrometer PL gel MIXED-D columns available from Varian Inc. (Palo Alto, Calif., USA).

Samples of polymeric solutions were prepared by dissolving dried polymer samples in tetrahydrofuran at a concentration of 1.0 percent (weight/volume). The samples were allowed to mix at low speed overnight on a mechanical shaker. After treating with diazomethane, the resulting solution was run through a 0.2 micrometer syringe filter and analyzed by SEC. The resulting samples were injected into the GPC and eluted at a rate of 1 milliliter per minute through the columns maintained at 35° C. The system was calibrated with polystyrene standards using a linear least squares analysis to establish a standard calibration curve. The weight average molecular weight (M_{w}) and the polydispersity index (weight average molecular weight divided by number average molecular weight (Mₙ)) were calculated for each sample against this standard calibration curve.

### Probe Tack Test

The probe tack test was used to identify the surface tackiness of the sample. Before the test, all of the samples except the aging sample were kept at room temperature for seven days after coating. For the probe tack test of the aging sample, the coated sample was kept at room temperature for s certain amount of time as indicated for each specific example.

To prepare specimen for probe tack test, sample strips having dimensions of 1 inch by 3 inches (2.5 cm by 7.6 cm) were cut. The samples specimens included a pressure-sensitive adhesive layer positioned between a polyester backing and a release liner. The sample strips were bonded to a clean glass with a double-sided tape. That is, the exposed surface of the polyester backing of the sample specimens were attached to clean glass with double-sided tape. The release liner was removed and the probe tack test was conducted on the surface of the PSA that had been in contact with the release liner. Test conditions used for the probe tack were as follows: 3 mm stainless steel probe, 0.05 mm/sec post-test speed, 1 minute contact time, and 2 mil (51 micrometer) height. The probe tack value was defined by the integration area of the stress-strain curve under the debonding process. A higher value corresponds to a surface having more tack.

### Determination of Peel Adhesion Force

Peel adhesion force was measured using adhesive tapes, which included a pressure-sensitive adhesive layer adjacent to a polyester film backing, prepared in the examples after removal of the release liner. A stainless steel panel was cleaned by wiping with acetone and heptane and then dried. Adhesive tapes measuring 13.0 mm wide by 10 to 12 cm long were adhered to the panel by rolling with a 2 kg hard rubber roller 2 times. The free end of the adhesive tape was doubled back so that the angle of removal was 180° and attached to the horizontal arm of an adhesion tester scale (SLIP/PEEL TESTER MODEL 3M90, obtained from Instrumentors Inc., Strongsville, Ohio, USA). The stainless steel plate was attached to the platform that moved at 12 inches per minute (30.5 centimeters per minute) away from the scale. The peel test was started after a 20 minute dwell time at room temperature and a dwell time of 4 hours at 65° C. The scale was read in ounces during the test as an average of the stabilized peel force. The number was then converted and reported as Newtons per decimeter (N/dm). Nine peel tests were run for each sample and averaged to yield the reported peel force.

### Atomic Force Microscopy (AFM)

Sample strips were adhered to a glass slide using double sided tape. More particularly, the polyester backing of each sample was adhered to glass with double sided tape and the release liner was removed. Adhesive samples were imaged using PEAKFORCE QNM (quantitative nano-mechanical mapping) on a BRUKER DIMENSION ICON instrument with an OTESPA-R3 cantilever (nominal spring constant=26 N/m). Peak force tapping differs from traditional tapping modes. Instead of oscillating the cantilever near resonance, the z-piezo oscillated the AFM head at 2 kHz, (well below the resonant frequency of the cantilever). The tip contacted the surface and the deflection was measured as a function of z-height of the AFM head. The feedback control loop monitored the maximum force the cantilever exerts on the sample and adjusted the height of the AFM head to maintain a force set point of 100 nN. Thus the topography of the surface was mapped, and the cantilever deflection signal was analyzed to map the nano-mechanical properties such as energy dissipation, adhesion, and modulus. The modulus maps were analyzed using “SPIP 3D IMAGE PROCESSING” software (available from Image Metrology, Horsholm, Denmark) to determine % area coverage by the crystals and crystal size. Individual crystal domains were segmented using a simple threshold cut-off chosen for each image between 0.75-2.5 GPa. The area coverage by crystals was determined to be the total area with a modulus greater than the cut-off. For each individual crystal domain, the length was defined as the long dimension of a bounding rectangle, and the breadth was defined as the short dimension of a bounding rectangle.

### Preparation of (Meth)acrylic-Based Polymeric Material

### Preparative Example 1 (PE-1):

To a 250 mL amber bottle was added 90.0 grams of EHA, 10.0 grams of AA, 20 grams of VOAc, 1.0 gram of IPA, and 0.250 grams of VAZO 67. Ethyl acetate was added to the final composition to provide 40 wt. % solids (45 wt. % solids with VOAc). The components of the bottle were thoroughly degassed using nitrogen, then sealed. The reaction was conducted in a LAUNDER-OMETER at 60° C. for 16 hours, and then at 67° C. for 8 hrs. Example compositions are shown in Table 3. The weight percentage of VOAc added that was actually incorporated into the resulting polymeric material is also shown in Table 3.

### Preparative Example 2 (PE-2):

To a 250 mL amber bottle was added 90.0 grams of EHA, 10.0 grams of AA, 20 grams of VOAc, 1.0 gram of IPA, and 0.250 grams of VAZO 67. Ethyl acetate was added to the final composition to provide 40 wt. % solids (45 wt. % solids with VOAc). The components of the bottle were thoroughly degassed using nitrogen, then sealed. The reaction was conducted in a LAUNDER-OMETER at 60° C. for 16 hours, and then at 67° C. for 16 hrs. Example compositions are shown in Table 3. The weight percentage of VOAc added that was actually incorporated into the resulting polymeric material is also shown in Table 3.

TABLE 3
(Meth)acrylic-based polymeric materails (PE-1 and PE-2)

| | | | Actual VOAc | Actual Product |
|---|---|---|---|---|
| | | | Incorporation, | EHA/AA/VOAc, |
| Sample | M_{w} (Da) | Wt. % solids | wt. % | wt. ratio |
| PE-1 | 752,500 | 40.0 | 40 | 83.3/9.3/7.4 |
| PE-2 | 655,000 | 43.0 | 60 | 80.4/8.9/10.7 |

### Preparation of the Coating Solutions

Coating solutions were prepared that contained both a fatty amide compound and a (meth)acrylic-based polymeric material dissolved in an organic solvent. The fatty amide compound was dissolved in toluene/IPA (90/10) first in a bottle, followed by the addition of a solution of the (meth)acrylic-acid based polymeric material (PE-1 or PE-2). The resulting mixture was rolled overnight for complete dissolution. The ratio of fatty amide compound to dry (meth)acrylic-based polymeric material is specified in the examples.

### Coating of the Pressure-Sensitive Adhesive Compositions

All adhesive samples, including the control without added fatty amide compound, were coated at 2 mil (51 micrometers) dry thickness on a polyester film (HOSTAPHAN 3SAB, available from Mitsubishi Polyester Film, Inc., Greer, S.C.) and then laminated with silicone coated 2 mil (51 micrometers) polyester release liner (CLEARSIL T50 Release liner, available from Solutia/CP Films, Martinsville, Va.). All coated samples were dried at 70° C. for 10 min, followed by drying at 130° C. for another 10 min to ensure the consistent migration of the fatty amide compound to the surface. After drying, the samples were kept at room temperature for seven days to ensure the crystallization of the fatty amide compound before the test.

### Example 1 (EX-1)

0.08 grams of stearamide was dissolved in 33 grams of toluene/IPA (90/10) first in a bottle under ambient environmental conditions, followed by the addition of 100 grams of the (meth)acrylic-based polymeric material solution (PE-1). The mixture was kept overnight on a roller under ambient environmental conditions for complete dissolution. The resulting clear solution contained a calculated 30 weight percent solids and a calculated 0.2 phr stearamide (0.2 parts stearamide per 100 parts of the (meth)acrylic-based polymeric material).

To the above prepared solution was added 0.8 mL of a 5 wt. % solution of BISAMIDE-1 in toluene, and then after an hour this solution was coated at 2 mil (51 micrometers) dry thickness on a polyester backing film and then laminated with a release liner. After drying, the sample was kept at room temperature for seven days to ensure the crystallization of the fatty amide compound before testing. The results from the probe tack test and peel strength test are summarized in Table 4. The mean crystal length was 0.04 micrometer and the mean crystal breadth was 0.02 micrometer. Total crystal phase area coverage was 2.2±0.7%.

### Comparative Example 1 (CE-1)

A comparative example (CE-1) was prepared without adding any fatty amide compound. To 100 grams of the (meth)acrylic-based polymeric material solution (PE-1) was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated with the release liner. The results from the probe tack test and peel strength test are summarized in Table 4. No crystalline material were observed using AFM.

TABLE 4
Tack and peel strength of PSAs for EX-1 to EX-5 and CE-1

| | | | Peel, | | | Average | |
|---|---|---|---|---|---|---|---|
| | SAM | Peel, 20 min, | 65° C./4 h, | Probe | Average | crystal | |
| | loading, | oz/in | oz/in | Tack, | crystal length, | breadth, | Crystal |
| Sample | (phr) | (N/dm) | (N/dm) | MPa | micrometer | micrometer | phase area, % |
| CE-1 | None | 73 | 134 | 6.24 ± 0.55 | none | none | none |
| | | (80) | (147) | | | | |
| EX-1 | 0.2 | 77 | 132 | 4.53 ± 0.25 | 0.04 | 0.02 | 2.2 ± 0.7 |
| | | (84) | (144) | | | | |
| EX-2 | 0.5 | 98 | 136 | 3.03 ± 0.27 | 0.65 | 0.23 | 5.7 ± 0.8 |
| | | (107) | (149) | | | | |
| EX-3 | 0.75 | 95 | 134 | 2.68 ± 0.52 | 3.13 | 1.86 | 39.5 ± 22.9 |
| | | (104) | (147) | | | | |
| EX-4 | 1 | 89 | 128 | 2.88 ± 0.01 | 2.51 | 1.50 | 20.6 ± 3.1 |
| | | (97) | (140) | | | | |
| EX-5 | 2 | 55 | 98 | 1.07 ± 0.04 | 3.11 | 2.11 | 70.5 ± 1.5 |
| | | (60) | (107) | | | | |

### Example 2 (EX-2)

0.20 grams of stearamide was dissolved in 33 grams of toluene/IPA (90/10) first in a bottle under ambient environmental conditions, followed by the addition of 100 grams of the (meth)acrylic-based polymeric material solution (PE-1). The mixture was kept overnight on a roller under ambient environmental conditions for complete dissolution. The resulting clear solution contained a calculated 30 weight percent solids and a calculated 0.5 phr stearamide (0.5 parts stearamide per 100 parts of the (meth)acrylic-based polymeric material).

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated with a release liner. After drying, the sample was kept at room temperature for seven days to ensure the crystallization of the fatty amide compound before testing. The results from probe tack test and peel strength test are summarized in Table 4. The mean crystal length was 0.65 micrometer and the mean crystal breadth was 0.23 micrometer. Total crystal phase area coverage was 5.7±0.8%.

### Example 3 (EX-3)

0.28 grams of stearamide was dissolved in 33 grams of toluene/IPA (90/10) first in a bottle under ambient environmental conditions, followed by the addition of 100 grams of the (meth)acrylic-based polymeric material solution (PE-1). The mixture was kept overnight on a roller under ambient environmental conditions for complete dissolution. The resulting clear solution contained a calculated 30 weight percent solids and a calculated 0.75 phr stearamide (0.75 parts stearamide per 100 parts of the (meth)acrylic-based polymeric material).

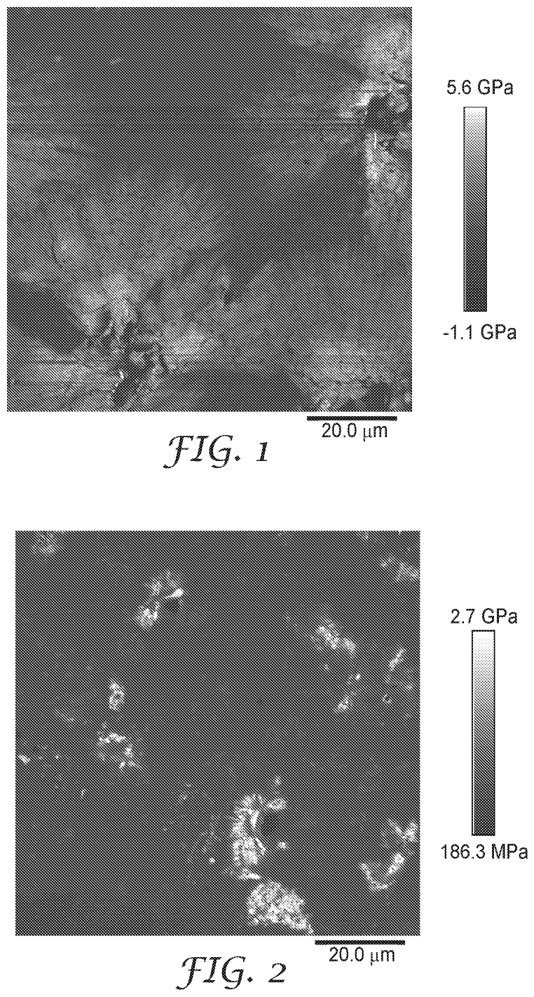

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample was kept at room temperature for seven days to ensure the crystallization of the fatty amide compound prior to testing. The results from probe tack test and peel strength test are summarized in Table 4. The AFM micrograph is shown in FIG. 1. The mean crystal length was 3.13 micrometer and the mean crystal breadth was 1.86 micrometer. Total crystal phase area coverage was 39.5±22.9%. The probe tack value of EX-3 as a function of aging time is shown at Table 5.

TABLE 5
Probe tack value of EX-3 as a function of aging time

| Aged days | 7 Days | 12 Days | 36 Days | 50 Days |
|---|---|---|---|---|
| Probe tack value | 2.68 ± 0.52 | 2.76 ± 0.26 | 1.68 ± 0.9 | 1.92 ± 0.61 |
| (MPa) | | | | |

### Example 4 (EX-4)

0.40 grams of stearamide was dissolved in 33 grams of toluene/IPA (90/10) first in a bottle under ambient environmental conditions, followed by the addition of 100 grams of the (meth)acrylic-based polymeric material solution (PE-1). The mixture was kept overnight on a roller under ambient environmental conditions for complete dissolution. The resulting clear solution contained a calculated 30 weight percent solids and a calculated 1.0 phr stearamide (1.0 part stearamide per 100 parts of the (meth)acrylic-based polymeric material).

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound prior to testing. The results from probe tack test and peel strength test are summarized in Table 4. The AFM micrograph is shown in FIG. 2. The mean crystal length was 2.51 micrometer and the mean crystal breadth was 1.50 micrometer. Total crystal phase area coverage was 20.6±3.1%.

### Example 5 (EX-5)

0.80 grams of stearamide was dissolved in 33 grams of toluene/IPA (90/10) first in a bottle under ambient environmental conditions, followed by the addition of 100 grams of the (meth)acrylic-based polymeric material solution (PE-1). The mixture was kept overnight on a roller under ambient environmental conditions for complete dissolution. The resulting clean solution contained a calculated 30 weight percent solids and a calculated 2.0 phr stearamide (2.0 parts stearamide per 100 parts of the (meth)acrylic-based polymeric material).

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound prior to testing. The results from probe tack test and peel strength test are summarized in Table 4. The AFM micrograph is shown in FIG. 3. The mean crystal length was 3.11 micrometer and the mean crystal breadth was 2.11 micrometer. Total crystal phase area coverage was 70.5±1.5%.

### Example 6 (EX-6)

0.086 grams of behenamide was dissolved in 33 grams of toluene/IPA (90/10) first in a bottle under ambient environmental conditions, followed by the addition of 100 grams of the (meth)acrylic-based polymeric material solution (PE-2). The mixture was kept overnight in a roller under ambient environmental conditions for complete dissolution. The resulting clear solution contained a calculated 30 weight percent solids and a calculated 0.2 phr behenamide (0.2 parts behenamide per 100 parts of the (meth)acrylic-based polymeric material).

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound prior to testing. The results from probe tack test and peel strength test are summarized in Table 6. The mean crystal length was 0.98 micrometer and the mean crystal breadth was 0.67 micrometer. Total crystal phase area coverage was 4.14±0.3%.

### Example 7 (EX-7)

0.86 grams of lauramide was dissolved in 33 grams of toluene/IPA (90/10) first in a bottle under ambient environmental conditions, followed by the addition of 100 grams of the (meth)acrylic-based polymeric material solution (PE-2). The mixture was kept overnight on a roller for overnight under ambient environmental conditions for complete dissolution. The resulting clear solution contained a calculated 30 weight percent solids and a calculated 2.0 phr lauramide (2.0 parts lauramide per 100 parts of the (meth)acrylic-based polymeric material).

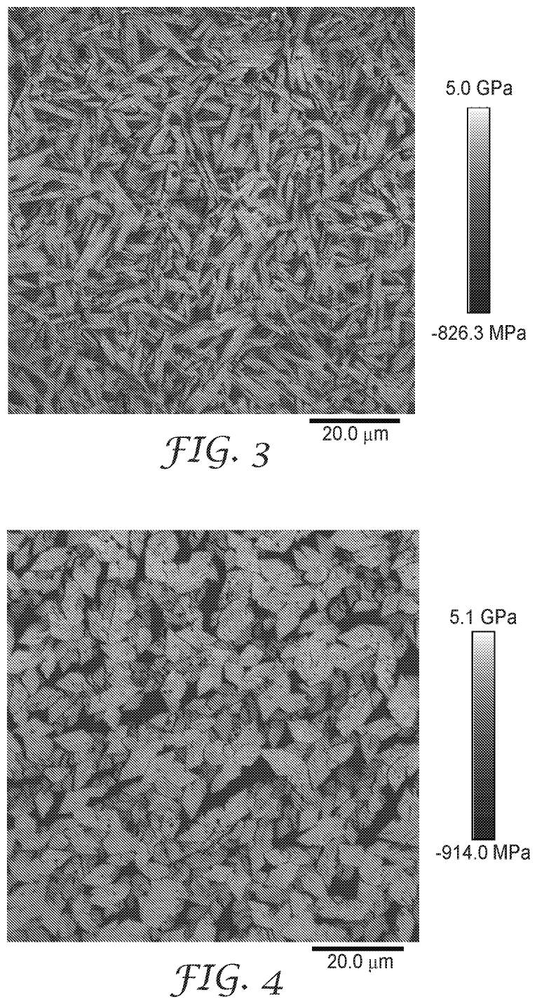

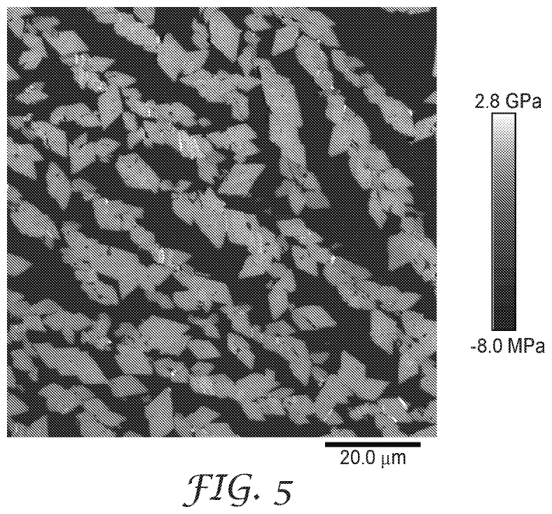

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound prior to testing. The results from probe tack test and peel strength test are summarized in Table 6. The AFM micrograph is shown in FIG. 4. The mean crystal length was 6.06 micrometer and the mean crystal breadth was 5.02 micrometer. Total crystal phase area coverage was 80.3±5.4%.

### Example 8 (EX-8)

0.86 grams of erucylamide was dissolved in 33 grams of toluene/IPA (90/10) first in a bottle under ambient environmental conditions, followed by the addition of 100 grams of the (meth)acrylic-based polymeric material solution (PE-2). The mixture was kept overnight on a roller under ambient environmental conditions for complete dissolution. The resulting clear solution contained a calculated 30 weight percent solids and a calculated 2.0 phr erucylamide (2.0 parts erucylamide per 100 parts of the (meth)acrylic-based polymeric material).

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound before testing. The results from probe tack test and peel strength test are summarized in Table 6. The AFM micrograph is shown in FIG. 5. The mean crystal length was 19.54 micrometer and the mean crystal breadth was 7.85 micrometer. Total crystal phase area coverage was 49.2±3.1%.

### Comparative Example 2 (CE-2)

0.086 grams of oleamide was dissolved in 33 grams of toluene/IPA (90/10) first in a bottle under ambient environmental conditions, followed by the addition of 100 grams of (meth)acrylic-based polymeric material (PE-2). The mixture was kept overnight on a roller under ambient environmental conditions for complete dissolution. The resulting clear solution contained a calculated 30 weight percent solids and a calculated 0.2 phr oleamide (0.2 parts oleamide per 100 parts of the (meth)acrylic-based polymeric material).

To the above made solution was added 0.8 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound before testing. The results from probe tack test and peel strength test are summarized in Table 6. No crystals were observed based on AFM.

TABLE 6
Tack and peel strength of PSAs for EX-6 to EX-8 and CE-1, CE-2

| | | | Peel, | Peel, | | Average | Average | |
|---|---|---|---|---|---|---|---|---|
| | | Fatty | 20 min, | 65° C./4 h, | Probe | crystal | crystal | Crystal |
| | Fatty | amide, | oz/in | oz/in | tack, | length, | breadth, | phase |
| Sample | Amide | phr | (N/dm) | (N/dm) | MPa | micrometer | micrometer | area, % |
| CE-1 | None | 0 | 73 | 134 | 6.24 ± 0.55 | none | none | none |
| | | | (80) | (147) | | | | |
| CE-2 | OAM | 0.2 | 76 | 142 | 7.14 ± 1.57 | none | none | none |
| | | | (83) | (155) | | | | |
| EX-6 | BAM | 0.2 | 80 | 139 | 5.41 ± 0.86 | 0.98 | 0.67 | 4.14 ± 0.3 |
| | | | (88) | (152) | | | | |
| EX-7 | LAM | 2.0 | 76 | 132 | 3.43 ± 0.23 | 6.06 | 5.02 | 80.3 ± 5.4 |
| | | | (83) | (144) | | | | |
| EX-8 | EAM | 2.0 | 77 | 136 | 1.76 ± 0.11 | 19.54 | 7.85 | 49.2 ± 3.1 |
| | | | (84) | (149) | | | | |

### Example 9 (EX-9)

To a 500 mL amber bottle was added 0.2 grams of stearamide, 90.0 grams of EHA, 10.0 grams of AA, 20 grams of VOAc, 2.50 gram of IPA, and 0.250 grams of VAZO 67. 147 grams of ethyl acetate was added to the final composition. The components of the bottle were thoroughly degassed using nitrogen and then sealed. The reaction was conducted in a LAUNDER-OMETER at 60° C. for 16 hours, and then at 67° C. for 7 hours. The resulting clear solution contained a calculated 41.5 weight percent solids and a calculated 0.2 phr stearamide (0.2 parts stearamide per 100 parts of the (meth)acrylic-based polymeric material). The estimated weight average molecular weight based on the intrinsic viscosity of the composition is 752,500 Da.

To the above prepared solution was added 2.13 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound before testing. The results from probe tack test and peel strength test are summarized in Table 7. Total crystal phase area coverage was 2.5±0.3%.

### Example 10 (EX-10)

To a 500 mL amber bottle was added 0.5 grams of stearamide, 90.0 grams of EHA, 10.0 grams of AA, 20 grams of VOAc, 2.50 gram of IPA, and 0.250 grams of VAZO 67. 147 grams of ethyl acetate was added to the final composition. The components of the bottle were thoroughly degassed using nitrogen, then sealed. The reaction was conducted in a LAUNDER-OMETER at 60° C. for 16 hours, and then at 67° C. for 7 hrs. The resulting clear solution contained a calculated 41.6 weight percent solids and a calculated 0.5 phr stearamide (0.5 parts stearamide per 100 parts of the (meth)acrylic-based polymeric material). The estimated weight average molecular weight based on the intrinsic viscosity of the composition is 752,500 Da.

To the above made solution was added 2.13 mL of a 5 wt. % solution of BISAMIDE-1 in toluene, and then after an hour this solution (including the BISAMIDE-1) was coated at 2 mil (51 micrometers) dry thickness on a polyester backing film and then laminated to a release liner. After drying, the sample were kept at room temperature for seven days to ensure the crystallization of the fatty amide compound before testing. The results from probe tack test and peel strength test are summarized in Table 7. Total crystal phase area coverage was 6.2±0.5%.

TABLE 7
Tack and peel strength of PSAs for EX-9 to EX-10

| | | Fatty | Peel, | Probe tack | Crystal |
|---|---|---|---|---|---|
| | Fatty | amide, | 20 min, oz/in | value, | phase |
| Sample | Amide | phr | (N/dm) | MPa | area, % |
| EX-9 | SAM | 0.2 | 71 | 5.06 ± 0.54 | 2.5 ± 0.3 |
| | | | (78) | | |
| EX-10 | SAM | 0.5 | 83 | 3.40 ± 0.25 | 6.2 ± 0.5 |
| | | | (91) | | |

1. An adhesive article comprising:
a first substrate; and
a pressure-sensitive adhesive layer adjacent to the substrate, wherein the pressure-sensitive adhesive comprises
1) a (meth)acrylic-based polymeric material comprising 1 to 15 weight percent polar monomeric units, wherein the polar monomeric units have a pendant hydroxyl group, a pendant carboxylic acid group, or both; and
2) crystalline materials on a surface of the pressure-sensitive adhesive layer opposite the substrate, the crystalline materials comprising an amide compound of formula R¹—(CO)NH—R²and having a melting point in a range of 80° C. to 140° C., wherein the pressure-sensitive adhesive layer comprises 0.1 to 5 parts of the amide compound per 100 parts of the (meth)acrylic-based polymeric material and wherein
R¹ is an alkyl or alkenyl groups having at least 11 carbon atoms; and
R² is hydrogen or an alkyl.

2. The adhesive article of claim 1, wherein the crystalline materials comprise lauramide, palmitamide, stearamide, behenamide, erucylamide, or a mixture thereof.

3. (canceled)

4. The adhesive article of claim 1, wherein the crystalline materials cover 1 to 90 percent of the geometric surface area of the pressure-sensitive adhesive layer opposite the first substrate.

5. The adhesive article of clam 1, wherein the (meth)acrylic-based polymeric material is crosslinked.

6. (canceled)

7. (canceled)

8. The adhesive article of claim 1, wherein the (meth)acrylic-based polymeric material is a polymerized product of a monomer composition comprising 40 to 100 weight percent of low Tg monomer (i.e., a monomer having a Tg no greater than 20° C. when homopolymerized), 0 to 15 weight percent polar monomer, 0 to 50 weight percent high Tg monomer (i.e., a monomer having a Tg greater than 50° C. when homopolymerized), 0 to 20 weight percent vinyl monomers that do not have a (meth)acryloyl group.

9. The adhesive article of claim 1, wherein the first substrate comprises a thermoplastic polymeric material.

10. The adhesive article of claim 1, wherein the surface of the pressure-sensitive adhesive layer opposite the first substrate is adhered to a second substrate.

11. A method of making an adhesive article, the method comprising:
forming a mixture comprising a solution comprising
1) a (meth)acrylic-based polymeric material comprising 1 to 15 weight percent polar monomeric units, wherein the polar monomeric units have a pendant hydroxyl group, a pendant carboxylic acid group, or both; and
2) a solution comprising an amide compound of formula R′-(CO)NH—R2 having a melting point in a range of 80° C. to 140° C., wherein the mixture comprises 0.1 to 5 parts of the amide compound per 100 parts of the (meth)acrylic-based polymeric material and wherein
R¹ is an alkyl or alkenyl groups having at least 11 carbon atoms thereof; and
R² is hydrogen or alkyl;
positioning a layer of the mixture adjacent to a first substrate; and
drying the mixture to form a pressure-sensitive adhesive layer positioned adjacent to the first substrate, wherein a surface of the pressure-sensitive adhesive layer opposite the first substrate comprises crystalline materials comprising the amide compound.

12. The method of claim 11, wherein the amide compound comprises lauramide, palmitamide, stearamide, behenamide, erucylamide, or a mixture thereof.

13. The method of claim 11, wherein the (meth)acrylic-based polymeric material is a polymerized product of a monomer composition comprising 40 to 100 weight percent of low Tg monomer (i.e., a monomer having a Tg no greater than 20° C. when homopolymerized), 0 to 15 weight percent polar monomer, 0 to 50 weight percent high Tg monomer (i.e., a monomer having a Tg greater than 50° C. when homopolymerized), 0 to 20 weight percent vinyl monomers that do not have a (meth)acryloyl group.

14. The method of claim 11, wherein the method further comprises crosslinking the (meth)acrylic-based polymeric material.
